(19) United States
(12) Patent Application Publication
(10) Pub. No.: US 2015/0302618 A1
(43) Pub. Date: Oct. 22, 2015

(54) SYSTEM, METHOD, AND COMPUTER READABLE STORAGE MEDIUM STORING A PROGRAM FOR GENERATING GEOMETRIC PATTERNS

(71) Applicant: Mohammad Ali YAGHAN, Amman (JO)

(72) Inventor: Mohammad Ali YAGHAN, Amman (JO)

(21) Appl. No.: 14/258,652

(22) Filed: Apr. 22, 2014

(51) Int. Cl. G06T 11/20

(52) U.S. Cl. CPC G06T 11/203; G06T 2210/12

(57) ABSTRACT

A method and apparatus which allow for the creation of patterns that simultaneously combine units based on any number of spaced points without the restriction of repetition, strict geometrical order, and regularity. Patterns can be created without repetition using dissimilar units over an underlying grid with any level of regularity or irregularity. The units are also not limited by strict geometric order and can encompass any level of regularity or irregularity. The method and system further allow for customization of the overall geometric pattern without being limited by the confinements exhibited by the traditional convention. Within regular shapes, the centers can also be shifted to create an infinite field of geometric patterns.

### BACKGROUND

1. Technical Field

One or more exemplary embodiments relate to a method, apparatus and a computer readable medium storing a program for generating geometric patterns.

2. Description of the Related Art

Traditional patterns, such as Islamic patterns, are created through repetition of one or more units over an underlying grid. The preeminent factors that affect the end-result include: the underlying grid, the unit shape, the complexity of the unit, and the method of connection between the units.

One unit can contain multiple concentric circles. Complexity may be demonstrated by increasing the number of points on a concentric circle and rotating the angle accordingly. Joining points between concentric circles allow for change in the complexity and overall structure of the geometric pattern. Common shapes developed within joined points of geometric patterns are stars, lozenges, petals, and arrows. The aforementioned shapes display a high degree of geometrical regularity and symmetry.

As a common practice, traditional patterns may be created via repetition of geometric patterns of corresponding units. Repeating the same unit on the major points of the underlying grid as shown in FIG. 3a will give off an illusion of continuity and will recreate a newly created geometric pattern. Often times, more than one unit may be repeated to create a totally different geometric pattern as shown in FIG. 3b.

The level of complexity of a unit lies in the number of concentric stars and flowers and their types, as seen in FIG. 4. Thus the same underlying grid arrangement can be used to create endless patterns of units based on the same number of points but with different levels of complexity, as shown in FIG. 5.

### SUMMARY

In traditional geometric patterns the points of these units are regularly distributed on the circumferences of concentric circles surrounding the center. The units themselves are always of high degree of regularity with many folds of symmetry.

Most traditional geometrical patterns are created through strict geometrical ordered repetition of one or a group of units. The number of points of a unit to be repeated is always controlled by the mathematical-geometrical characteristics of the underlying grid, the unit, and the other units in a group (if more than one unit was repeated). Thus the patterns are always governed by repetition and strict geometrical regularity.

This strict geometrical order allows for only a limited variety in the number of points of units used simultaneously in one pattern. For example 8-point-based units are either repeated or grouped with units based on points relative to the mathematical equation Σₙ₌₁ 4n. Thus, traditionally, units based on 4-7-8-9-10-17 points, for example, could never be brought together simultaneously to form a pattern.

Traditional patterns also deal with the concept of “adjacency” when it comes to the relation between the units, thus lacking uniqueness and differentiation from other geometrical patterns.

Non-limiting embodiments of the present application, however, provide the ability of creating units within units allowing one to generate a multitude of geometrical designs different from that of the traditional method.

Non-limiting embodiments of the present application further allow for the creation of patterns that, simultaneously, combine units based on any number of points without the need for repetition or strict order. Overall geometric designs are not bounded by regularity or underlying grid with demanding geometrical constraints.

One of the objectives of the present application is to allow for the distribution of points along concentric circles, and other regular and irregular shapes in a customizable manner, thereby allowing for ease and convenience in generating distinct geometric patterns. In addition, within regular shapes, the centers can also be shifted to create an infinite genre of geometric patterns, whereas in the related art method, geometric patterns must be bounded by strict regularity and form.

Accordingly, a non-limiting embodiment provides a method for generating a geometric pattern, using one or more processors, including generating a contour; creating a plurality of units within the contour; assigning a plurality of key points within each of the respective plurality of units; distributing a plurality of points regularly or irregularly along a boundary of the plurality of units with respect to the assigned plurality of corresponding key points; and bounding a plurality of shapes based on the plurality of points distributed regularly or irregularly along the boundary of the plurality of units and the assigned plurality of corresponding key points.

The method may further include identifying a plurality of regions resulting from the bounded plurality of shapes.

The method may further include removing the plurality of units based on the bounded plurality of shapes.

The key points may be assigned at any point within boundaries of each of the respective plurality of units.

The plurality of units may include a first unit and a second unit, and the second unit may intersect the first unit.

The second unit may intersect the first unit by at least one of a single point, by circles of varying sizes, and by regular or irregular contours.

Another non-limiting embodiment provides a non-transitory computer-readable storage medium storing a program for generating a geometric pattern, the program including functions of generating a contour; creating a plurality of units within the contour; assigning a plurality of key points within each of the respective plurality of units; distributing a plurality of points regularly or irregularly along a boundary of the plurality of units with respect to the assigned plurality of corresponding key points; and bounding a plurality of shapes based on the plurality of points distributed regularly or irregularly along the boundary of the plurality of units and the assigned plurality of corresponding key points.

The program may further include the functions of identifying a plurality of regions resulting from the bounded plurality of shapes.

The program may further include the functions of removing the plurality of units based on the bounded plurality of shapes.

The key points may be assigned at any point within boundaries of each of the respective plurality of units.

The plurality of units may include a first unit and a second unit, and the second unit may intersect the first unit.

The second unit may intersect the first unit by at least one of a single point, by circles of varying sizes, and by regular or irregular contours.

Another non-limiting embodiment provides an apparatus for generating a geometric pattern, including one or more processors configured to generate a contour; create a plurality of units within the contour; assign a plurality of key points within each of the respective plurality of units; distribute a plurality of points regularly or irregularly along a boundary of the plurality of units with respect to the assigned plurality of corresponding key points; and bound a plurality of shapes based on the plurality of points distributed regularly or irregularly along the boundary of the plurality of units and the assigned plurality of corresponding key points.

The one or more processors may be further configured to identify a plurality of regions resulting from the bounded plurality of shapes.

The one or more processors may be further configured to remove the plurality of units based on the bounded plurality of shapes.

The key points may be assigned at any point within boundaries of each of the respective plurality of units.

The plurality of units may include a first unit and a second unit, and the second unit may intersect the first unit.

The second unit may intersect the first unit by at least one of a single point, by circles of varying sizes, and by regular or irregular contours.

### BRIEF DESCRIPTION OF DRAWINGS

FIG. 1a-1f are different types of grids that allow for strict geometrical order and regularity;

FIG. 2a illustrates an example of a 12-point unit with concentric stars as the geometrical pattern, FIG. 2b illustrates adding a new concentric circle with twice the number of points to create two different types of flowers as the geometrical pattern, FIG. 2c illustrates resultant regions within the units, and FIG. 2d highlights the symmetry of each resultant region;

FIG. 3a illustrates traditional patterns based on repetition of a single underlying grid, and FIG. 3b illustrates traditional patterns based on repetition of two different units;

FIG. 4 illustrates complexity of traditional patterns based on quantity of regions and their types;

FIG. 5 illustrates traditional patterns based on repetition of a single underlying grid with different levels of complexity;

FIG. 6a illustrates repetition of a single unit on an underlying grid with one point connection, FIG. 6b illustrates repetition of a single unit on an underlying grid with two point connection, FIG. 6c illustrates repetition of a single unit on an underlying grid with simultaneous one point and two point connection, and FIG. 6d illustrates repetition of a single unit on an underlying grid with a tilted point connection;

FIG. 7 illustrates units created within units;

FIG. 8a illustrates traditional patterns with ordered shapes, FIG. 8b illustrates points regularly and irregularly distributed on a concentric circle, FIG. 8c illustrates points regularly and irregularly distributed on a rectangle and a triangle, FIG. 8d illustrates points regularly and irregularly distributed on an irregular shape, and FIG. 8e illustrates points regularly and irregularly distributed on a concentric circle with a shifted center;

FIG. 9a illustrates underlying grids created by circles of different sizes intersecting on a single point, FIG. 9b illustrates underlying grids created by circles of different sizes intersecting with different levels of order, FIG. 9c illustrates underlying grids created by circles of the same size irregularly intersecting with different levels of order, and FIG. 9d illustrates underlying grids created by intersecting lines or curves with any level of regularity or irregularity;

FIG. 10a illustrates key points located at the center of concentric circles and its respective geometric pattern, FIG. 10b illustrates key points located anywhere in a concentric circle and its respective geometric pattern, and FIG. 10c illustrates key points bounded by linear regions and its respective geometric pattern;

FIGS. 11a-11h illustrate an example of generating a geometric pattern from start to finish according to a non-limiting embodiment of the generation process;

FIG. 12 illustrates a completed geometric pattern;

FIG. 13 illustrates various completed geometric patterns;

FIG. 14a illustrates an example subject, FIG. 14b is the example subject filled by geometrical patterns in reference to the traditional method, and FIG. 14c is the example subject filled by geometrical patterns in reference to a non-limiting embodiment;

FIG. 15 illustrates examples of how an object can be filled by geometrical patterns in reference to a non-limiting embodiment;

FIG. 16a illustrates a bounded region, FIG. 16b illustrates a unit added in different locations and its respective resulting regions, FIG. 16c illustrates the boundaries surrounding the resulting region, and FIG. 16d illustrates how a unit can be translated or scaled;

FIGS. 17a-17c illustrate an example of adding units and how resulting regions are stored in region stacks;

FIG. 18 is an illustration of a completed circle-based creation process according to a non-limiting embodiment;

FIG. 19 illustrates a flowchart of a geometric pattern generation process according to a non-limiting embodiment;

FIG. 20a illustrates a creation process flowchart for irregular lines and curve-based layout (e.g., FIG. 9d type) according to a non-limiting embodiment, and FIG. 20b illustrates an editing process flowchart according to a non-limiting embodiment;

FIG. 21 illustrates the editing process of independent units according to a non-limiting embodiment; and

FIG. 22 illustrates the editing process of multiple units according to a non-limiting embodiment.

### DETAILED DESCRIPTION OF EXEMPLARY EMBODIMENTS

All terms including descriptive or technical terms which are used herein should be construed as having their plain and ordinary meanings. However, the terms may have different meanings according to an intention of one of ordinary skill in the art, precedent cases, or the appearance of new technologies. Also, some terms may be arbitrarily selected by the applicant, and in this case, the meaning of the selected terms will be described in detail in the detailed description. Thus, the terms used herein have to be defined based on the meaning of the terms together with the description throughout the specification.

Also, when a part “includes” or “comprises” an element, unless there is a particular description contrary thereto, the part may further include other elements, not excluding the other elements. In the following description, terms such as “unit” and “module” indicate a unit for processing at least one function or operation, wherein the unit and the block may be embodied as hardware or software or may be embodied by combining hardware and software.

One or more exemplary embodiments will now be described more fully with reference to the accompanying drawings. However, the one or more exemplary embodiments may be embodied in many different forms, and should not be construed as being limited to the exemplary embodiments set forth herein. Rather, these exemplary embodiments are provided so that this disclosure will be thorough and complete, and will fully convey the concept of the one or more exemplary embodiments to those of ordinary skill in the art. In the following description, well-known functions or constructions are not described in detail since they would obscure the one or more exemplar embodiments with unnecessary detail, and like reference numerals in the drawings denote like or similar elements throughout the specification.

Hereinafter, a non-limiting embodiment of a geometrical pattern generating method, an apparatus and a computer readable medium storing a program to execute the geometrical pattern generating method will be described in accordance with the attached drawings.

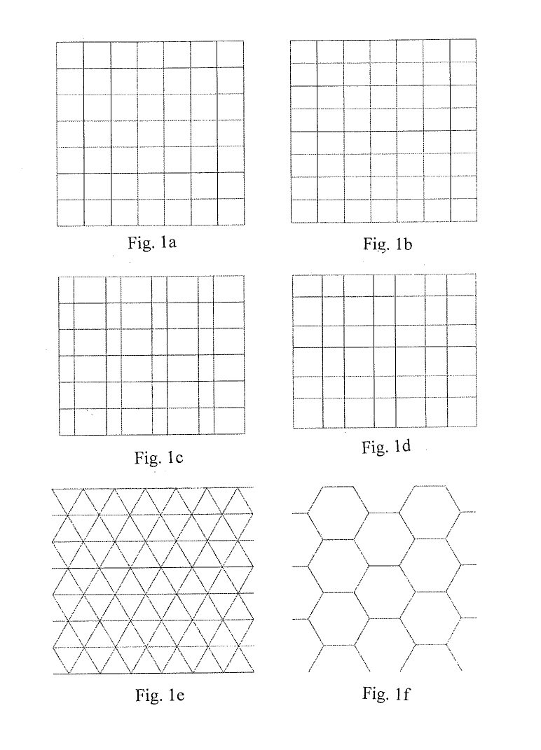

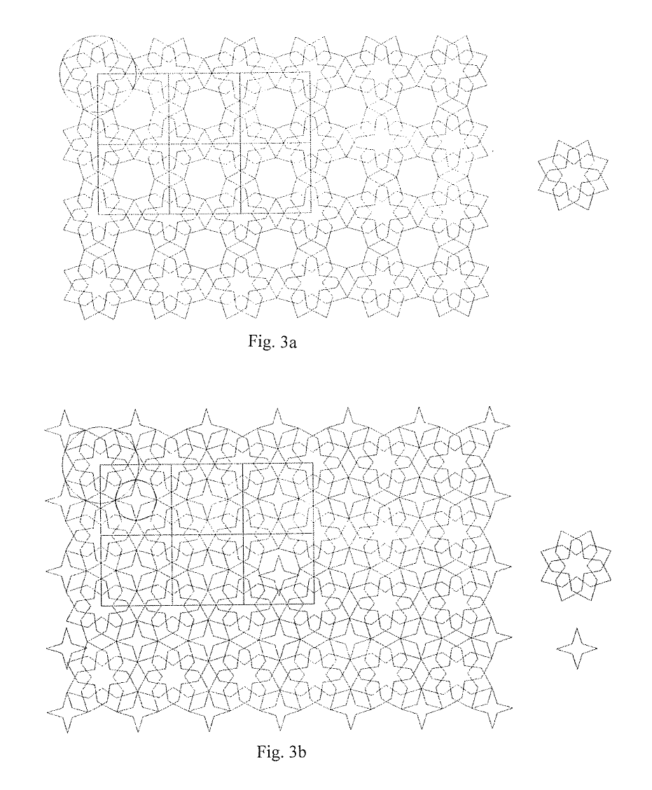

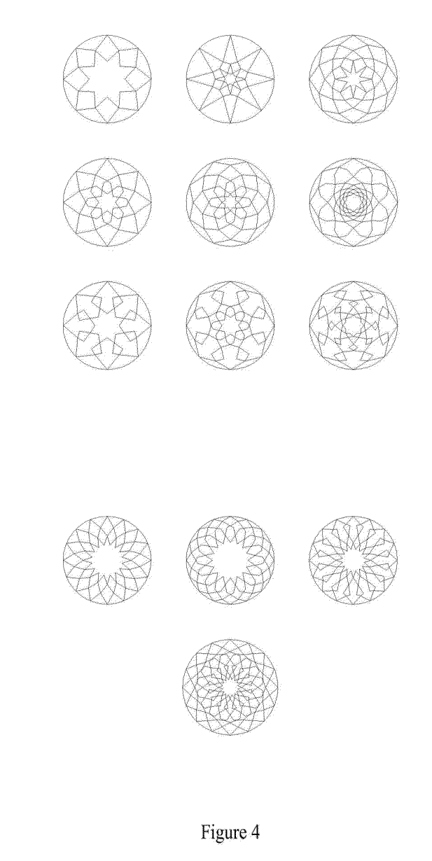

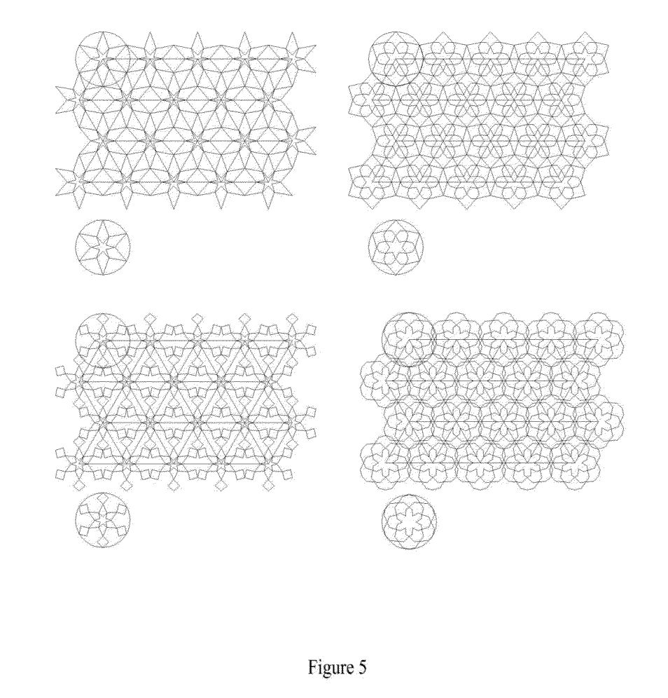

It will be readily understood that the components of the present invention, as generally described and illustrated in the figures herein, may be arranged and designed in a wide variety of different configurations. Thus, the following more detailed description of the embodiments of the method, the apparatus and the computer readable storage medium storing a program, as represented in FIGS. 1-22, is not intended to limit the scope of the invention, as claimed, but is merely representative of selected embodiments of the invention.

Referring now to FIGS. 1a-1f, there are depicted various types of grids that can accommodate repetition. Square (FIG. 1a), rectangle (FIG. 1b), double rectangle (FIG. 1c), triple rectangle (FIG. 1d), triangle (FIG. 1e), and hexagonal grids (FIG. 1f) are represented and are all types of strict geometrical order and regularity. Some of the two-dimensional tessellations mentioned can be used to create an underlying grid.

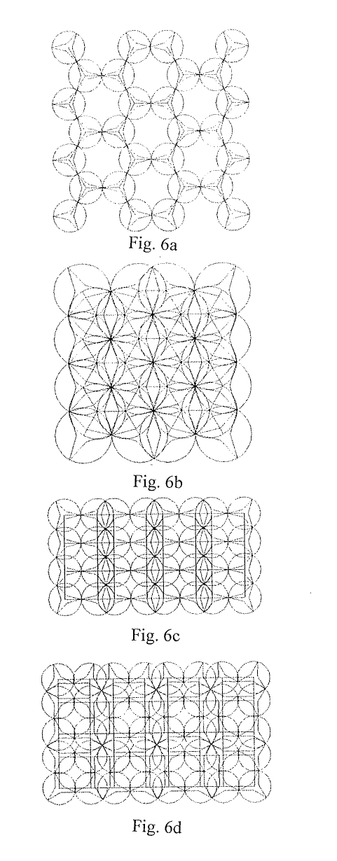

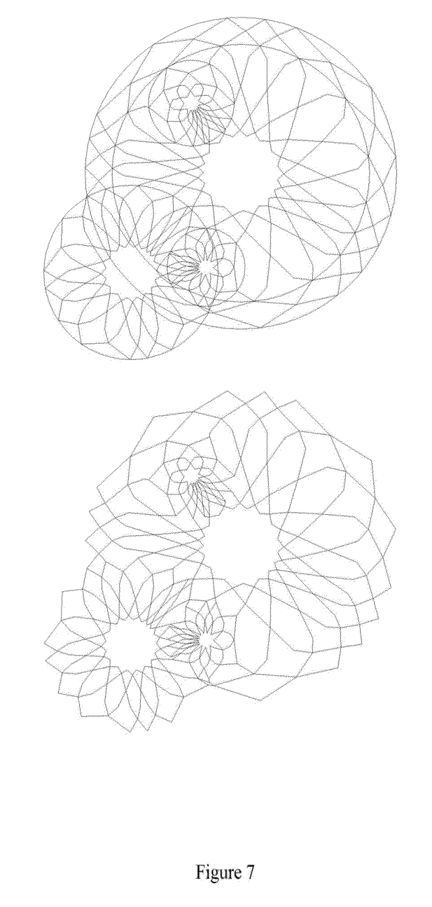

Specifically, the same unit could be repeated on the same grid with different types of connections resulting in different patterns. These connection types are; one point connection FIG. 6a, two-point connection FIG. 6b, simultaneous one and two point connection FIG. 6c, and a point connection with a tilt FIG. 6d. The traditional patterns, also, dealt only with the concept of “adjacency” when it comes to the relation between the units. For example, the exemplary embodiments of the geometrical pattern generation process disclosed herein is not limited to “adjacency” but also “containment” wherein the units can be connected by various connection points within other units as shown in FIG. 7.

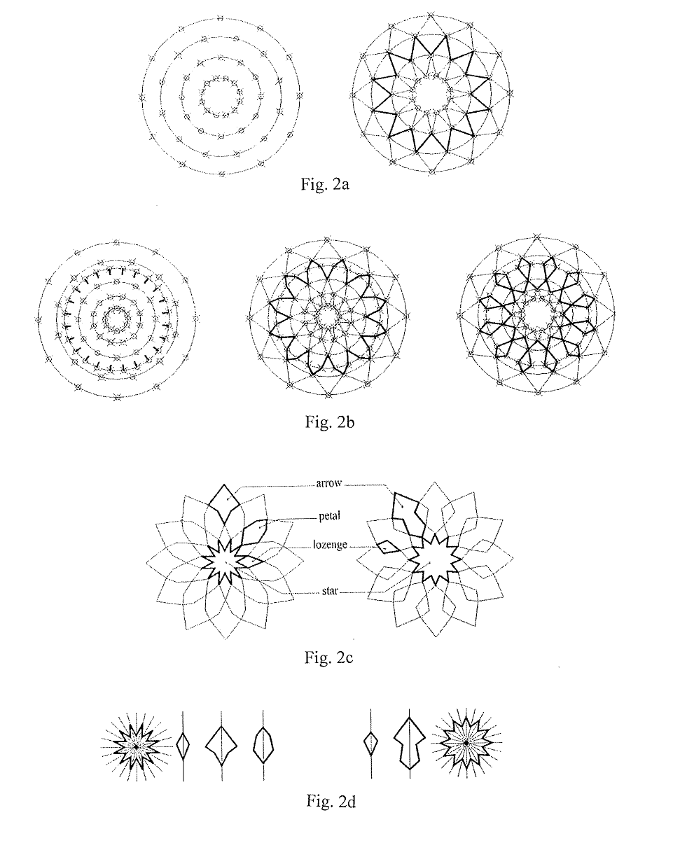

A repeated unit is a shape resulting from an ordered group of lines joining ordered groups of points distributed evenly on the circumferences of concentric circles around one center. The number of these points on a circle defines the unit, for example “five-point unit”, or “eight-point unit” . . . etc. The illustrative example of FIG. 2a depicts the positioning of points on the concentric circles. Every point on every other circle is rotated at an angle equal to half of the angle between the lines joining the center and any two consecutive points. The unit is, thus, created by joining the points of the consecutive circles in an ordered manner. The resulting shape of this illustrative example is a group of concentric stars as shown in FIG. 2b. Based on the underlying grid and complexity of the geometrical pattern, different shapes can be created. For example, there are two different geometrical patterns with a 12 point unit shown in FIG. 2c. Both are created with different complexity, and thus, create a diverse assortment of shapes. FIG. 2d illustrates the symmetry in the shapes of each 12 point unit geometrical pattern.

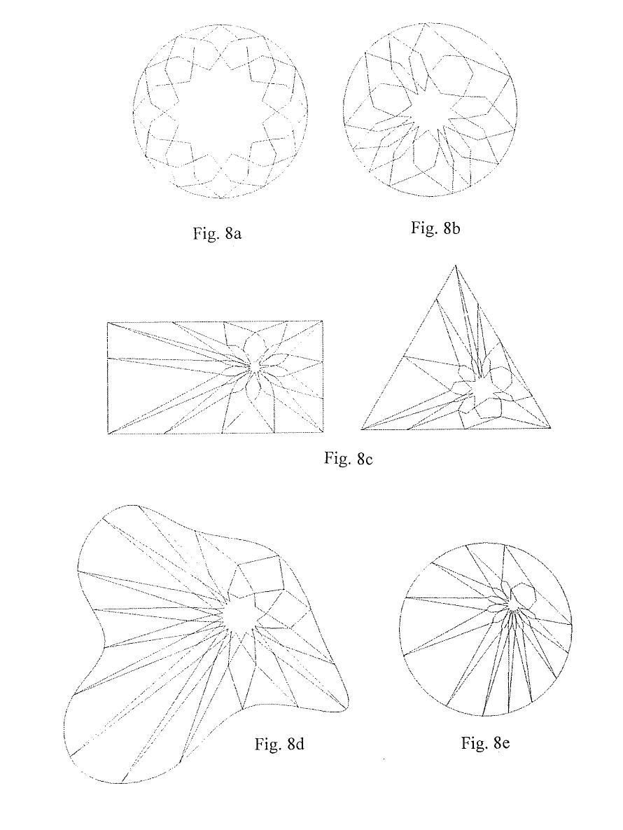

The exemplary embodiments of the geometrical pattern generation process disclosed herein are not bounded by the realms of regular or irregular shapes, nor are they bounded by regular or irregular points surrounding a shape. For example, one may choose to create a regular shape such as a concentric circle and populate the concentric circle with regularly spaced points to generate a traditional geometric pattern as shown in FIG. 8a. However, one is not limited to this example and may choose to use points irregularly spaced as shown in FIG. 8b to generate the geometric pattern. In addition, one is not limited to the concentric circle, but may use a regular or irregular outside shape such as those shown in FIGS. 8c-8e.

In particular, FIG. 8a illustrates traditional patterns with ordered shapes, FIG. 8b illustrates points regularly and irregularly distributed on a concentric circle, FIG. 8c illustrates points regularly and irregularly distributed on a rectangle and a triangle, FIG. 8d illustrates points regularly and irregularly distributed on an irregular shape, and FIG. 8e illustrates points regularly and irregularly distributed on a concentric circle with a shifted center.

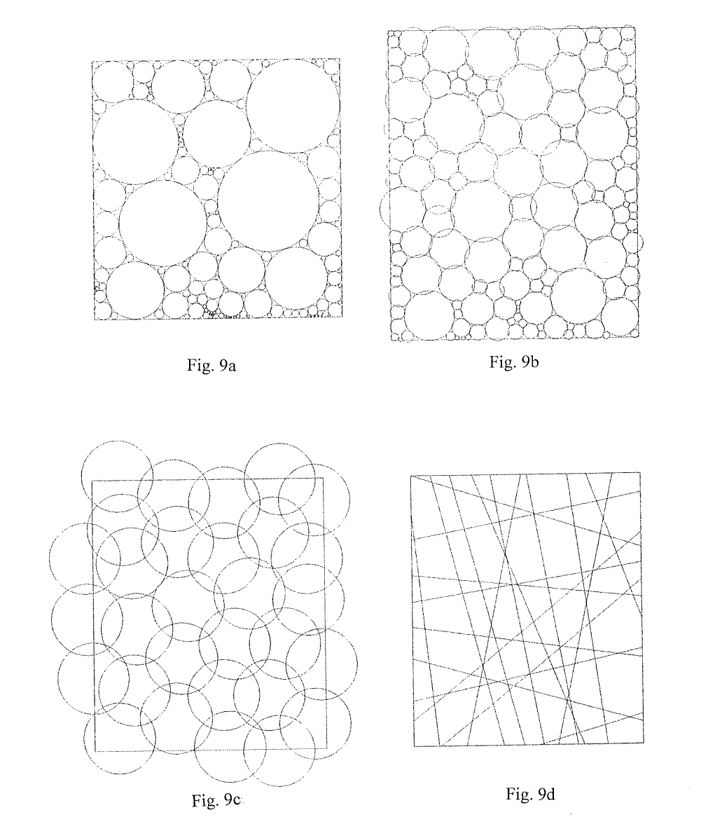

The non-limiting embodiment includes at least two creation processes, one for the underlying grids in reference to “circle-based creation process” and another for an underlying grid in reference to “irregular lines and curves-based process.” The underlying grid can be formed from circles of different sizes connected through a single point, from circles of different sizes intersecting with different levels of order, and/or irregularly intersecting circles of the same size. These are examples of a “circle-based creation process”. However, one is not limited to only strict geometrical order and can resort to curves of irregularity. For example, a group of intersecting lines or curves with any level of regularity or irregularity can be used as an underlying grid and is an example of an “irregular line and curve-based process”. The aforementioned underlying grids of this exemplary embodiment are shown in FIGS. 9a-9d.

The “circle-based creation process” and the “irregular line and curve-based process” are described, by way of an example, to give step by step procedures. However, it will be understood by one of ordinary skill in the art that a combination of regular and irregular contours may be combined to form an infinite range of underlying grids. Various changes in form and detail may be made therein without departing from the spirit and scope of the present application. Therefore, the present application is not limited thereto.

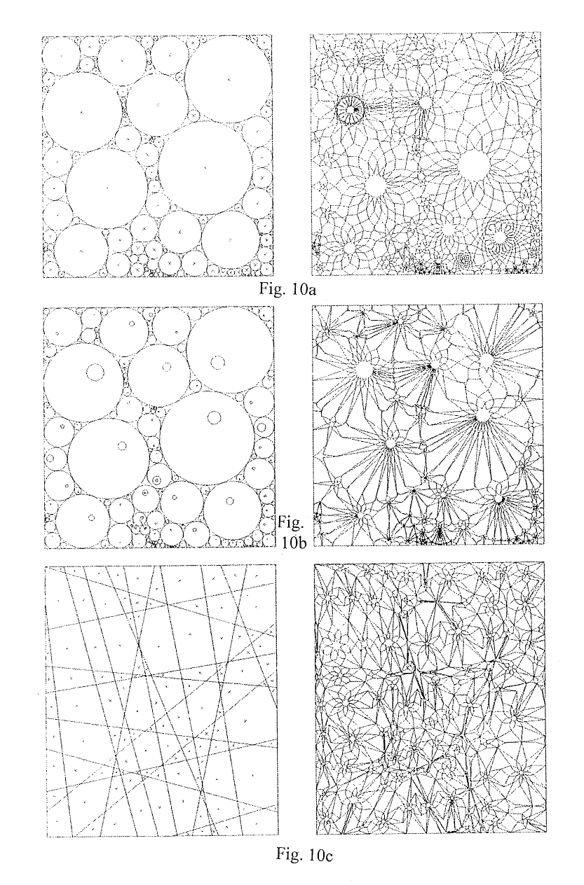

One can position the units on key points of different regions of underlying grids to appropriately customize the geometric design to their liking. These key points could be the actual centers of the circles, if circles exist, or any point within the circle or the region bounded by linear lines as shown in FIGS. 10a-10c. The units positioned on these key points are stars, flowers or the combination of the two, and are based on the number of points around the key points.

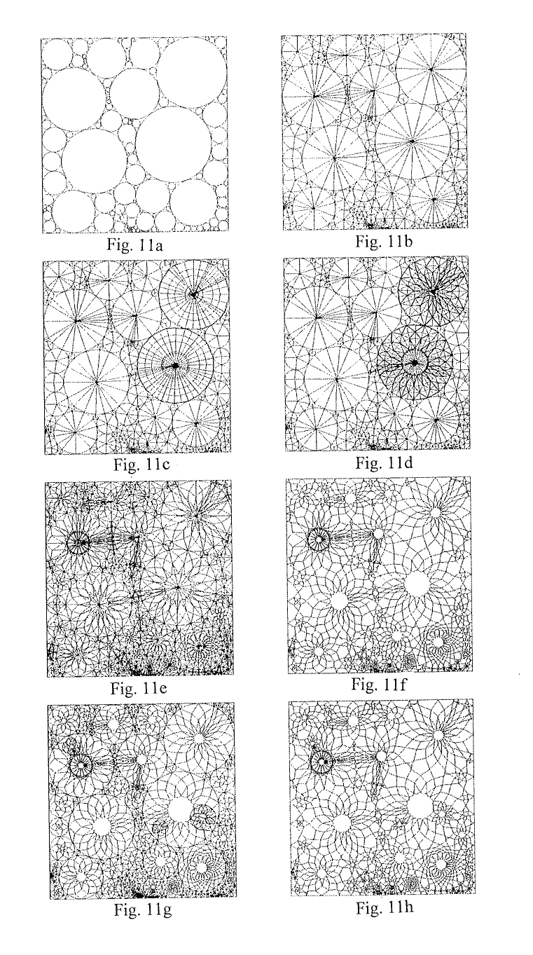

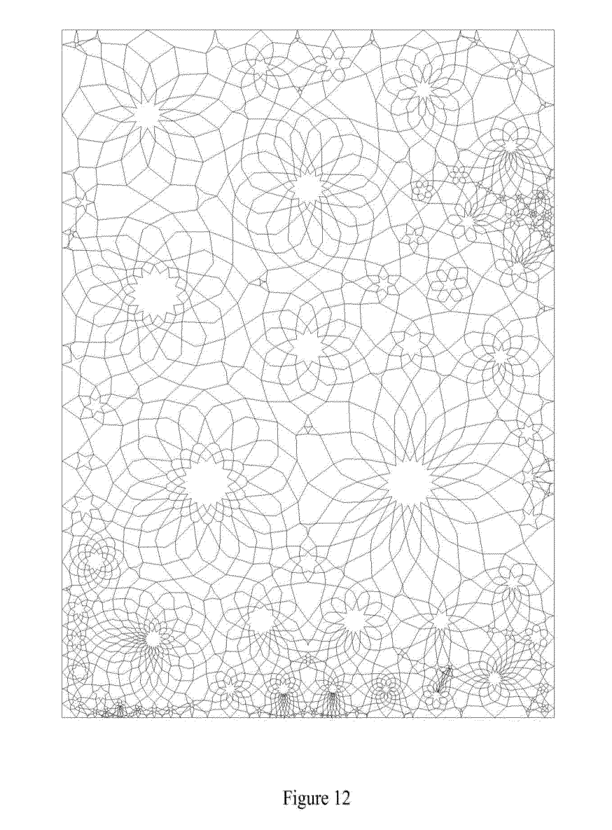

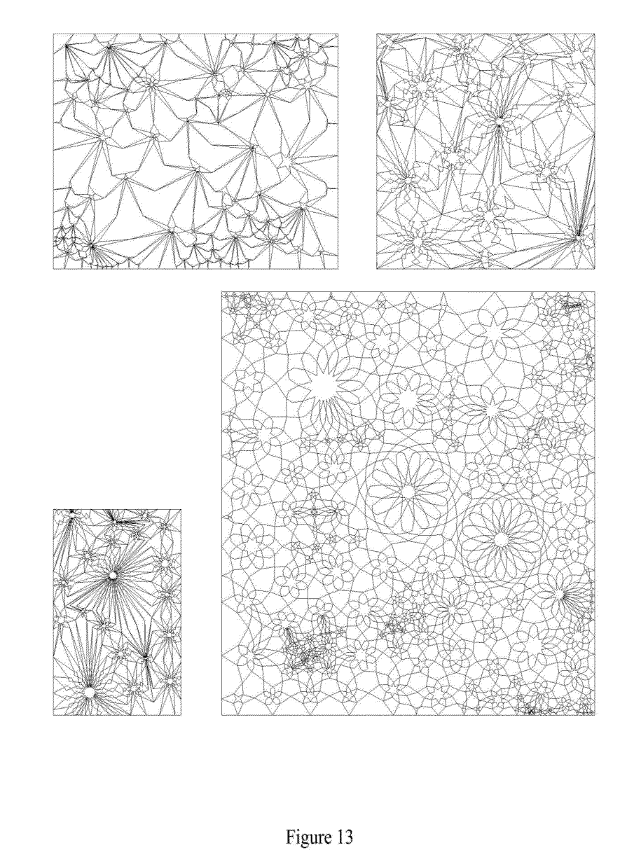

FIGS. 11a-11h illustrate an example of generating a geometric pattern from start to finish according to a non-limiting embodiment of the generation process. The illustration is based on underlying grids created by circles of different sizes intersecting on a single point as shown in FIG. 9a. The completed geometric pattern is illustrated in FIG. 12, and other geometric patterns according to a non-limiting embodiment of a generation process are shown in FIG. 13.

The geometric patterns illustrated according to a non-limiting embodiment may be used for surface design of any contour. Traditional patterns are limited by strict geometric regular contours. However, if a traditional pattern was bounded by an irregular contour, parts of the units will always be cut out. On the other hand, geometric patterns of this exemplary embodiment can fit perfectly in any contour or shape.

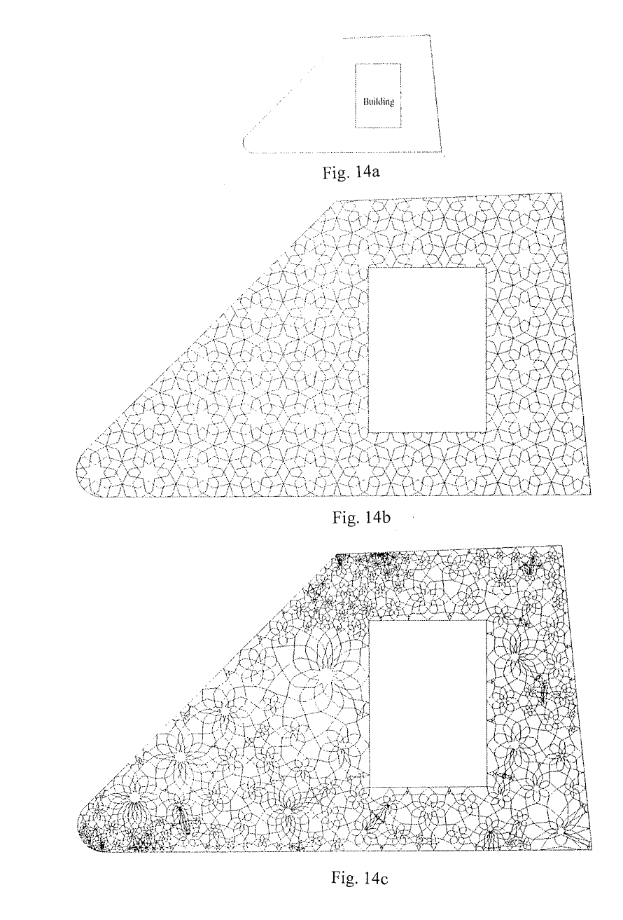

For example, FIG. 14a illustrates a situation where a contour is not created by strict regularity, i.e. square, rectangle, circular, etc., but rather an irregular contour. To cover such contour with the traditional geometric pattern, units on the edge will always be cut, thus hurting the visual continuity and definition of the space as shown in FIG. 14b. The geometric pattern of this exemplary embodiment allows units to fit exactly within the irregular contour as shown in FIG. 14c.

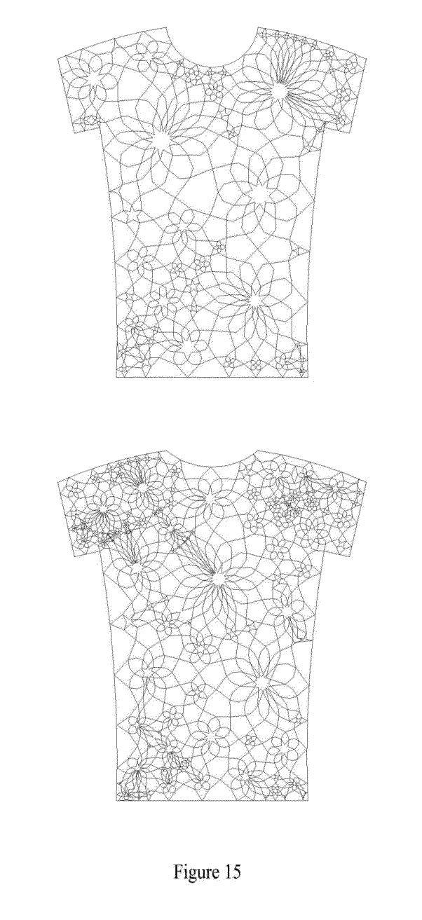

Another example of this exemplary embodiment is shown in a garment design, where one would be able to fill in the irregular boundaries of each piece of the garment as shown in FIG. 15.

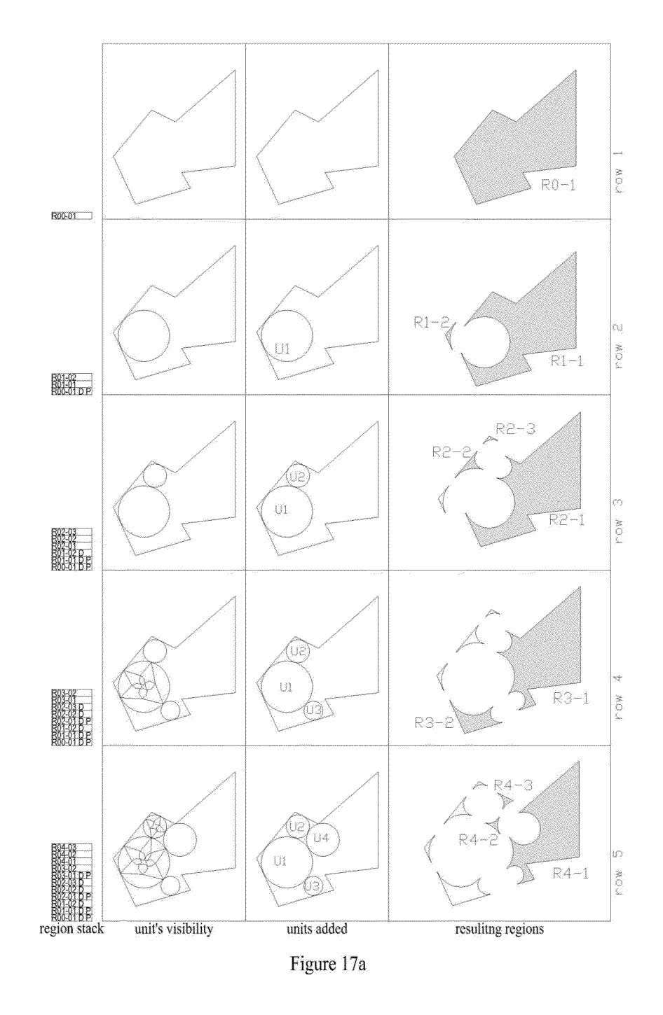

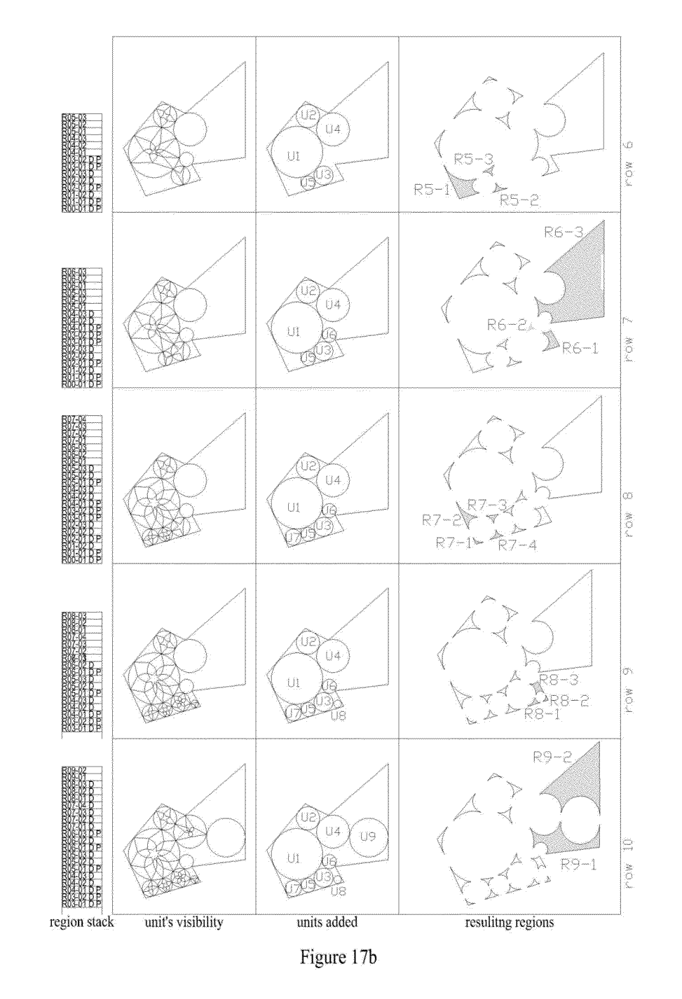

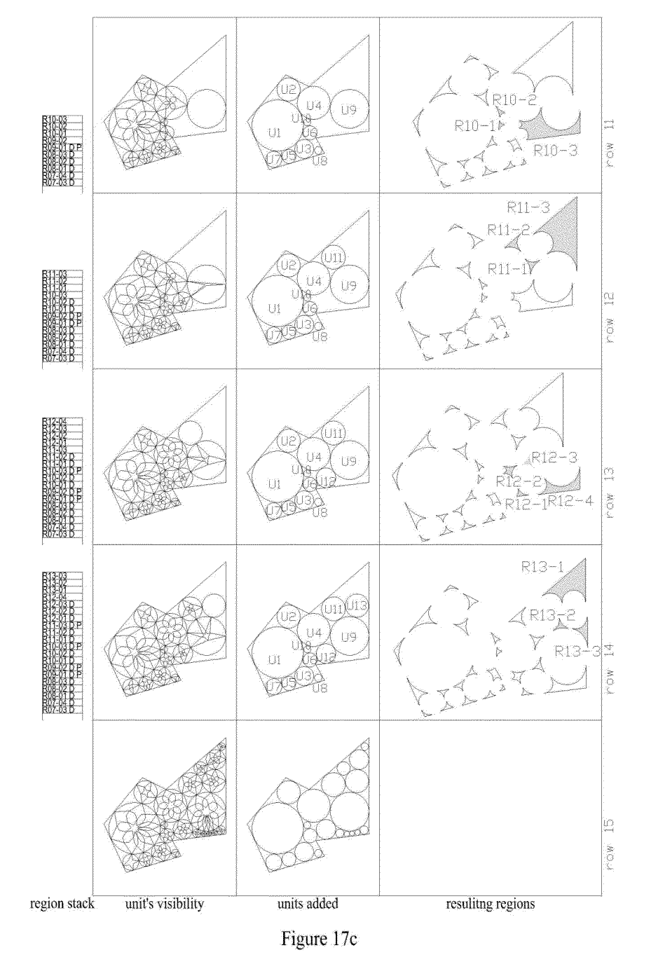

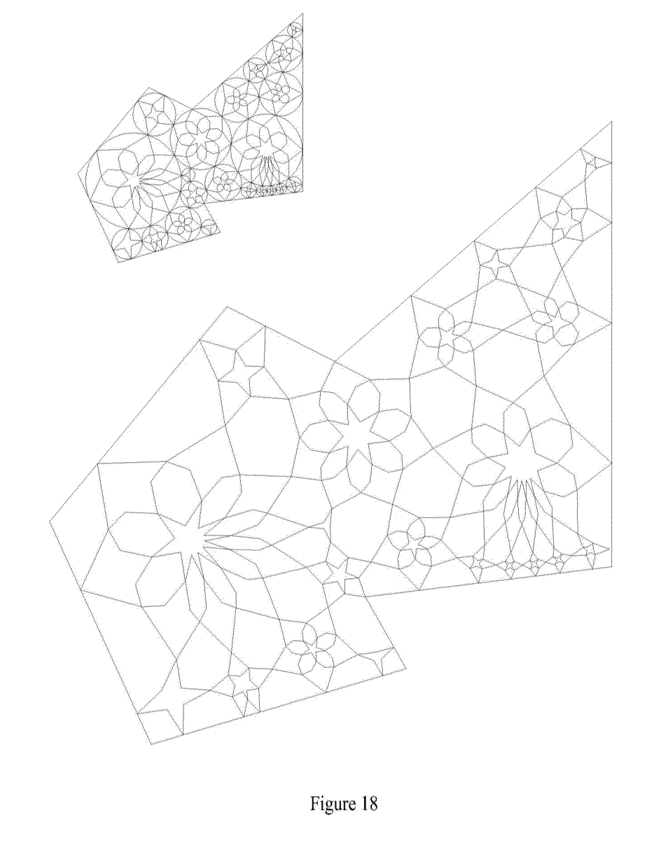

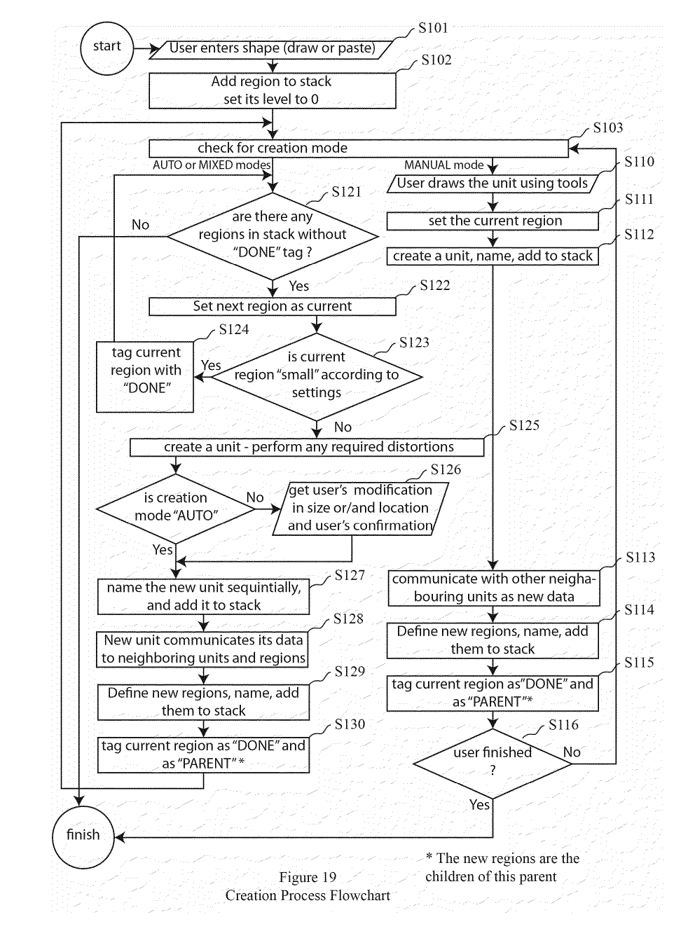

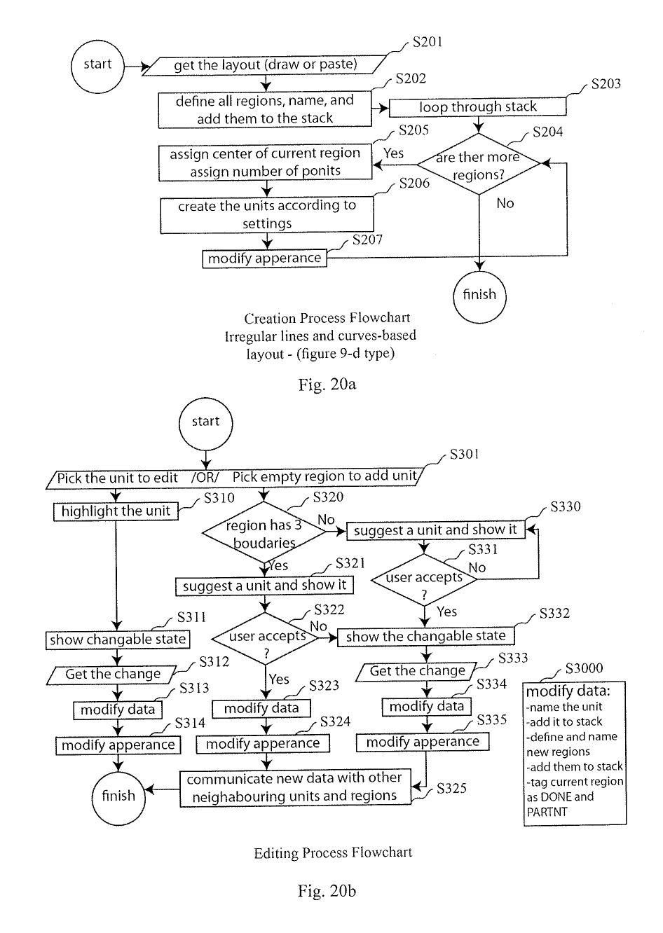

A description of the process of pattern creation now follows with reference to FIGS. 17a-17c and FIG. 18. The description applies to the computer generated method (in manual or auto modes) but it is noted that it could also apply to a computer-aided hand drawn method.

The first step is to define the area to be filled with patterns, which would constitute region R0-1 (e.g., see the first row in FIG. 17a).

Next, the first circle (which will hold a unit later, thus named U1) will be inserted. This insertion will be done visually (for the computer-generated manual mode) or according to a certain threshold defined by the settings of the program. This stage will divide R0-1 into two new regions R1-1 and R2-1, and thus, R0-1 will be tagged as “PARENT” and as “DONE” (e.g., see the second row in FIG. 17a where R00-01 (i.e., R0-1) is tagged as “PARENT” and “DONE” by “P” and “D”, respectively).

Next, a second circle (U2) will be inserted (according to similar logic as discussed above). This stage will divide R1-1 into three regions (R2-1, R2-2, and R2-3), and thus R1-1 will be tagged as “PARENT” and as “DONE” (e.g., see the third row in FIG. 17a).

Next R1-2 will be checked, and due to its size (visually small or under a pre-defined threshold) it will be tagged as “DONE” only and it will not be divided any further (and thus R1-2 will not be tagged as “PARENT”) (e.g., see the third row in FIG. 17a).

The program (or the drafter) will then step through/traverse the regions R2-1, R2-2, and R2-3 in order and through their children, if any, until all regions are tagged “DONE” (e.g., see the fourth through fourteenth rows in FIGS. 17a-c).

Next the key point in each circle would be defined according to the settings in the computer-generated technique (the key points can also be visually defined in the hand drawn technique).

The number of points in each unit is determined by the unit's intersection points with neighboring units and with the boundaries of the original area. In one exemplary embodiment, an intersection is defined as an actual intersection at one or two points, or as a proximity intersection for circles that are very close to each other (e.g., within a certain threshold, or visually close). The proximity intersection is calculated to be the midpoint between the two circles.

Next, in the computer-generated technique, the software program will create the units according to the settings (e.g., 8a-e and 10a-c). The units could be shown along the process of creation and changed each time a new circle is added. In the hand-drawn technique, the user would draw, using the software program, the resulting unit according to the visual appearance (type of flower, number of stars, stars radii) of his choice.

For the final pattern, the user (or the program) would omit/remove the circles as shown in FIG. 18, which illustrates the design produced by carrying out the operations shown in FIGS. 17a-c.

In FIGS. 17a-c and 18, the system that was applied is that of circles with a single point of intersection, and full containment within the boundaries of the area defined in the first step. However, circles could have two points of intersection and could jet outside the boundaries (as seen in FIGS. 9b and 9c). The system could also be of any other shape whether regular or irregular (as seen in FIGS. 9d and 10c), and still, the same concepts discussed above will apply to the design process.

Characterization to both processes will be made in reference to FIGS. 9a-9d, FIGS. 17a-17c, and flow charts of FIGS. 19, 20a, and 20b. The flow charts shown in FIGS. 19, 20a, and 20b can be implemented by way of software executed on one or more central processing units (CPUs).

As noted earlier, the first creation process is circle-based. Initially, the user defines the default settings grouped into six categories explained in the settings section. A region's stack and a unit's stack are defined by the program. The user can define the area to be filled with patterns by drawing a specific design or pasting a pattern from another application (operation S101). The process will start by adding the area in the previous step to the regions stack with its level as 0 (operation S102). Accordingly, auto and mixed mode, or manual mode may be chosen as a route of generating a geometrical pattern (operation S103).

If auto and mixed mode is chosen the program will check to see if the regions in the stack have a DONE tag (operation S121). If all regions in the stack have a DONE tag then the program will finish, otherwise the program will continue to the next region in the stack and set it as the current region (operation S122). The current region is checked to see if it is small (small is defined by the settings) (operation S123). If current region is small then no other unit will be allowed inside the current region and the program will tag the current region with DONE (operation S124) and the process returns to S121, otherwise, it will proceed to operation S125, in which a unit will be created within the current region and any required distortion will be filtered.

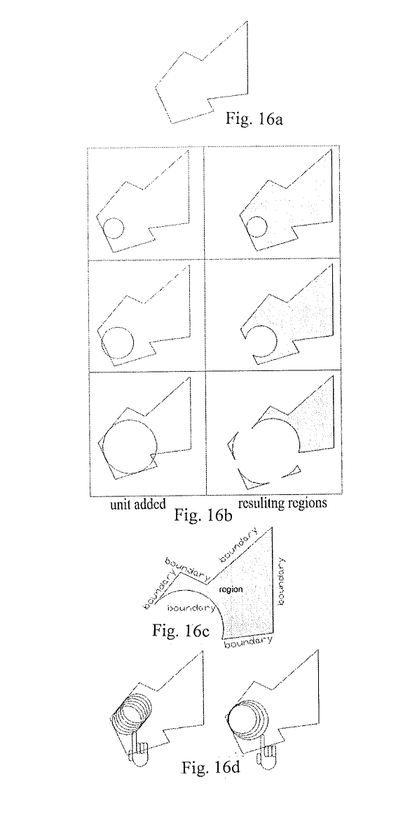

At this point, if the creation mode was MIXED then the program will wait for the user's approval of modifications in size and/or location (operation S126). The program will suggest a circle (based on the settings of the proposed units) and waits for the user's action. The user may scale or translate the unit along within or along the boundaries as shown in FIG. 16d. The location of the unit will distinguish the regular or irregular contour by resulting regions which are surrounded by the boundary as shown in FIGS. 16a-16c. Otherwise, the creation mode is changed to AUTO mode (operation S127) wherein the program automatically modifies the size and/or location.

Currently, a unit has been input and has been modified depending on the mode specified (i.e. AUTO or MIXED). A new unit is created and named sequentially to that of the previous unit (operation S127). The newly added unit now becomes the current unit. The current unit is added into the unit's stack and communicates its data to neighboring units and regions (operation S128). The communication of data between neighboring units and regions creates new regions. The program may name the new regions as shown in FIGS. 17a-17c and add them to the region's stack (operation S129). After new regions are named and added to stack, the program can tag the current region as DONE and as PARENT (as letters “D” and “P” respectively), as shown in FIGS. 17a-17c. Each time a unit is created within a region, the region is tagged as PARENT. The process will go back to operation S103. The program then checks for any change in the creation mode the user might have requested. If user checks MIXED then the process will continue in a similar fashion.

However, if user changes the settings to MANUAL mode, the user is allowed the ability to customize the contour of the unit using varying tools (operation S110) and place contour within the bounds of the shape (operation S111). The placement of the contour is referred to as the current region. After a unit is created, a current region may be set according to the user's choice of location. The unit is created, named sequentially and added into the unit's stack (operation S112). The new unit will be referred to as the current unit. The current unit will communicate its data to the neighboring units and regions (operation S113). The communication of data between neighboring units and regions will create new resulting regions as shown in FIGS. 17a-17c. If a single unit exists within the bounds of the shape, the region outside the unit but in between the shape is the resulting region or regions. However, if more than one unit exists, the resulting region is bounded by the outside contour and the regions adjacent to the current region.

The user will define the chosen regions and the program can name them accordingly. The new regions are added into the region's stack (operation S114). If the current region is applied as intended, the program can tag the current region as DONE and as PARENT, shown in FIGS. 17a-17c as letters “D” and “P”, respectively (operation S115). The resulting regions will be stored in the regions stack by a title followed by a DONE tag and a PARENT tag. The newly created regions are the children of this parent

The program goes to operation S116 where the user can decide to continue at which point the program will check for a creation mode S103, otherwise the program will end. The completed process of the example created by FIGS. 17a-17c in reference to flowchart of FIG. 19 is shown in FIG. 18.

FIG. 20a is an illustration designated to the creation process of irregular and curve based lines. The user can define a region by drawing a specific design or pasting a pattern from another application (operation S201). The user will use the creation tools and other varying tools to draw a unit. Accordingly, the location will be set as the “current region” and the regions will be defined, named and added to the stack (operation S202). The program will loop through the stack (operation S203) and look for any regions that have not been processed (operation S204). If more regions exist, either the program or the user will assign a center of the current region and assign a number of points along the unit depending on if it's in AUTO mode or MANUAL mode respectively (operation S205). Another unit can then be created, named, and added into the unit's stack (operation S206). The user may then modify the appearance of the units, regions and points within the geometric pattern (operation S207). However, if no more regions exist, the program will finish.

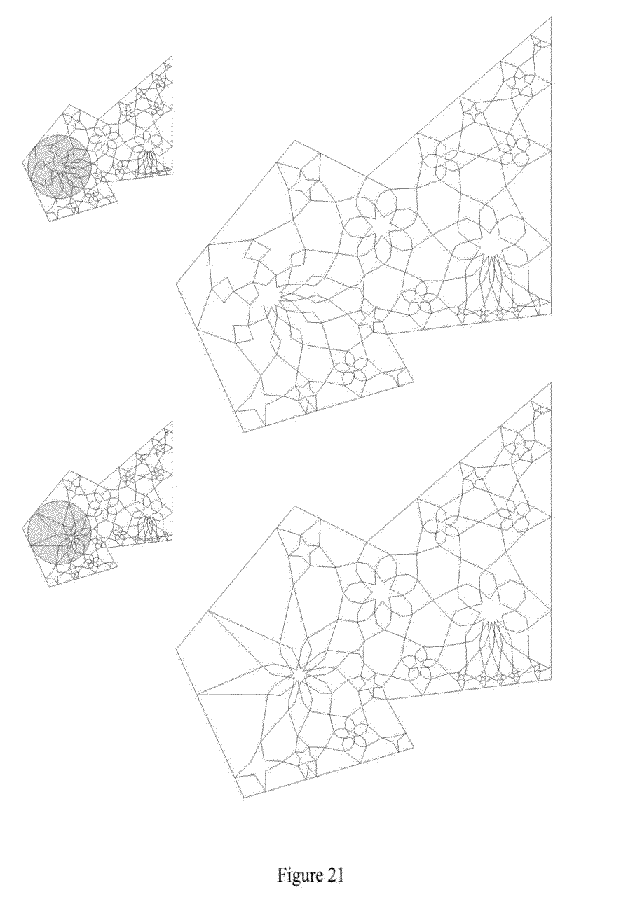

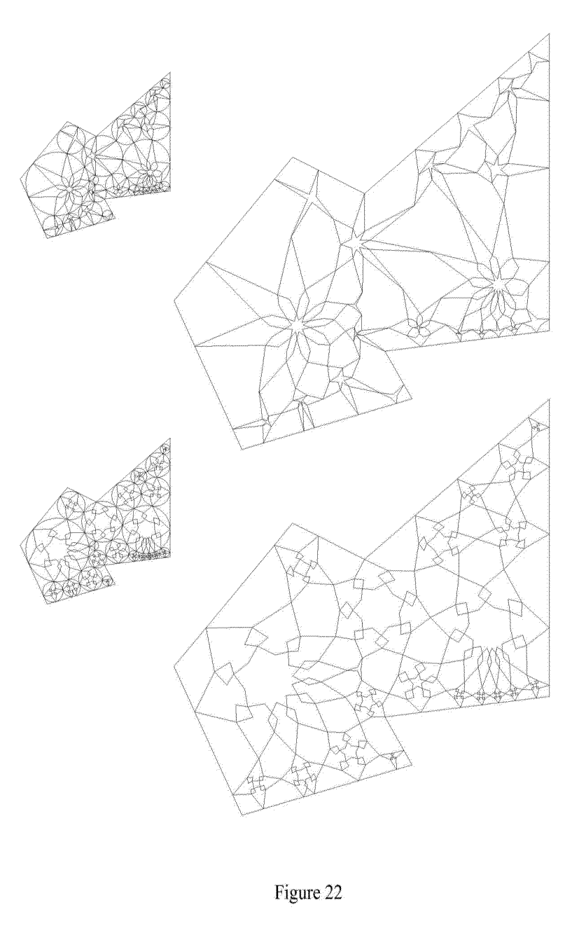

Referring now to FIG. 20b, after a design is created, it can be always edited by the user, where he can modify the state of the created units individually (e.g., FIG. 21), the states of all units in general (e.g., FIG. 22); or add new units in the empty regions. The user picks a unit to modify or an empty region to add a unit (operation S301). The user may highlight a preexisting unit that needs modification (operation S310). The program will show its current state with the changeable fields indicated (operation S311), and receive the necessary change from the user input (operation S312). The user may then confirm the necessary change at which the program modifies the data (operation S313) and the appearance (operation S314) of the highlighted unit. Once all the highlighted units are modified, the program will finish.

If a user would like to modify the overall geometrical pattern by adding new units in an empty region, then the user will select the region at which it will be set as “current region.” If the region is bounded by three regions (operation S320) then only one unit can fit within the space. The program will suggest a unit that is shown in the geometrical pattern (operation S321). The user can choose to accept the suggested unit created by the program (operation S322). If accepted, then modification of the data (operation S323) and the appearance (operation S324) is made in accordance to operation S3000, which shows in detail the operations of the modification step shown in step S313, S323, and S334. The new data is then communicated with other neighboring units and regions (operation S325) at which point the program ends. If the user does not accept the suggested unit at operation S322, then the program shows the changeable state (operation S332), and gets the change provided by the user S333. Modification of the data (operation S334) and the appearance (operation S335) is made in accordance to operation S3000. The new data is then communicated with other neighboring units and regions S325 at which point the program ends.

However, if the empty region is not bounded by three regions, the program will still suggest a unit that is shown in the geometrical pattern (operation S330). The user can choose to accept the suggested unit created by the program (operation S331). If the unit is accepted, then the program will continue in the usual route to operations S332-S35 and then to S325 as described earlier, however, if the suggested unit is not accepted at S331, the program will suggest and show other units within the open region until the user accepts.

As disclosed earlier, the user can define the default settings which are grouped into five categories and are shown below:

1) Creation mode (AUTO, MANUAL, MIXED)

2) Underlying grid type:
i.) SPCC—single point connected circles (FIG. 9a)
ii.) 2PCC—double point connected circles (FIG. 9b)
iii.) IRCC—irregularly connected circles (FIG. 9c)
iv.) IRLC—irregular lines and curves (FIG. 9d)

3) Default unit's state:
i.) visibility of units (circles, detailed unit with circles, detailed unit without circles)
ii.) unit classification (if the area of a unit compared to the overall original area is less than 10 percent, for example, then it is considered small otherwise it is considered large)
iii.) unit default components (for large units: stars, flower a, and flower b; for small units: two stars) These are the components and can be altered based on user preference. However, the components cannot be shown for units with one or two point connections, or if the points are not distributed along the circumference in a way to allow for a star or flower to exist.

4) Basis of unit creation:

There can be a multitude of criteria for unit creation in AUTO and MIXED modes, however, one is not limited to the examples mentioned below.
i.) bounded and touching one, two or three boundaries
ii.) the size of the region is small based on a threshold that can be altered in the settings
iii.) the level of contrast in sizes required by the user
iv.) the level of complexity intended for the design
v.) user's involvement (especially in MIXED mode)
vi.) important nodes (if defined by user)
vii.) distortion level: having more points in a unit would lessen the overall distortion of its components, thus, the user can define “less distortion” or “more distortion” modes

5) Measuring units:

This setting is concerned with the actual meaning of one unit in the real world (i.e. 1 mm, 1 cm, 1 m, . . . etc.) which can be a useful guide for printing and scaling the drawings accordingly.

### States and Methods of Units and Regions

In the exemplary embodiments discussed herein, units and regions are treated as objects. Each has a state with changeable fields, and methods to perform actions and communicate the values of its state fields and change them. For example the “number of points” is a field of the state of the unit; it is altered in response to a new neighboring unit being created or deleted. The following are the states and methods for the units and regions:

State of a Unit:
i.) name
ii.) visibility
iii.) circle center
iv.) circle radius
v.) composition center
vi.) unit's points
vii.) each point's connection to other units
viii.) neighboring regions
iv.) composing parts (stars, flower a, flower b)
v.) classification (small or large)

Methods of a Unit:
i.) I am initiated, contacting the neighboring unit's and regions
ii.) I am killed, contacting the neighboring unit's and regions
iii.) there is a distortion
iv.) get the composition center
v.) set the composition center
vi.) get the composing parts
vii.) set the composing parts

State of a Region
i.) its name
ii.) its level
iii.) composing boundaries
iv.) area
v.) neighboring unit's and regions
vi.) DONE tag
vii.) PARENT tag

Methods of a Region
i.) get the area
ii.) is a point inside?
iii.) set tag DONE
iv.) set tag PARENT
v.) define the possible unit's (or a possible unit)

One or more exemplary embodiments may also be embodied as programmed commands to be executed in various computer means, and then may be recorded to a computer-readable storage medium. The computer-readable storage medium may include one or more of the programmed commands, data files, data structures, or the like. The programmed commands recorded to the computer-readable storage medium may be particularly designed or configured for one or more exemplary embodiments. Examples of the computer-readable storage medium include magnetic media including hard disks, magnetic tapes, and floppy disks, optical media including CD-ROMs and DVDs, magneto-optical media including optical disks, and a hardware apparatus designed to store and execute the programmed commands in ROM, RAM, a flash memory, and the like. Examples of the programmed commands include not only machine codes generated by a compiler but also include great codes to be executed in a computer by using an interpreter. The hardware apparatus may be configured to function as one or more software modules so as to perform operations of one or more exemplary embodiments.

It should be understood that the exemplary embodiments described herein should be considered in a descriptive sense only and not for purposes of limitation. Descriptions of features or aspects within each embodiment should typically be considered as available for other similar features or aspects in other embodiments.

While one or more exemplary embodiments have been described with reference to the figures, it will be understood by those of ordinary skill in the art that various changes in form and details may be made therein without departing from the spirit and scope of the inventive concept as defined by the following claims.

1. A method for generating a geometric pattern, using one or more processors, comprising:
generating a contour;
creating a plurality of units within the contour;
assigning a plurality of key points within each of the respective plurality of units;
distributing a plurality of points regularly or irregularly along a boundary of the plurality of units with respect to the assigned plurality of corresponding key points; and
bounding a plurality of shapes based on the plurality of points distributed regularly or irregularly along the boundary of the plurality of units and the assigned plurality of corresponding key points.

2. The method of claim 1, further comprising:
identifying a plurality of regions resulting from the bounded plurality of shapes.

3. The method of claim 2, further comprising:
removing the plurality of units based on the bounded plurality of shapes.

4. The method of claim 1, wherein the key points can be assigned at any point within boundaries of each of the respective plurality of units.

5. The method of claim 1, wherein the plurality of units includes a first unit and a second unit, and the second unit intersects the first unit.

6. The method of claim 5, wherein the second unit intersects the first unit by at least one of a single point, by circles of varying sizes, and by regular or irregular contours.

7. A non-transitory computer-readable storage medium storing a program for generating a geometric pattern, the program comprising functions of:
generating a contour;
creating a plurality of units within the contour;
assigning a plurality of key points within each of the respective plurality of units;
distributing a plurality of points regularly or irregularly along a boundary of the plurality of units with respect to the assigned plurality of corresponding key points; and
bounding a plurality of shapes based on the plurality of points distributed regularly or irregularly along the boundary of the plurality of units and the assigned plurality of corresponding key points.

8. The non-transitory computer-readable storage medium of claim 7, wherein the program further comprises the functions of:
identifying a plurality of regions resulting from the bounded plurality of shapes.

9. The non-transitory computer-readable storage medium of claim 8, wherein the program further comprises the functions of:
removing the plurality of units based on the bounded plurality of shapes.

10. The non-transitory computer-readable storage medium of claim 7, wherein the key points can be assigned at any point within boundaries of each of the respective plurality of units.

11. The non-transitory computer-readable storage medium of claim 7, wherein the plurality of units includes a first unit and a second unit, and the second unit intersects the first unit.

12. The non-transitory computer-readable storage medium of claim 11, wherein the second unit intersects the first unit by at least one of a single point, by circles of varying sizes, and by regular or irregular contours.

13. An apparatus for generating a geometric pattern, comprising:
one or more processors configured to:
generate a contour;
create a plurality of units within the contour;
assign a plurality of key points within each of the respective plurality of units;
distribute a plurality of points regularly or irregularly along a boundary of the plurality of units with respect to the assigned plurality of corresponding key points; and
bound a plurality of shapes based on the plurality of points distributed regularly or irregularly along the boundary of the plurality of units and the assigned plurality of corresponding key points.

14. The apparatus of claim 13, wherein the one or more processors are further configured to:
identify a plurality of regions resulting from the bounded plurality of shapes.

15. The apparatus of claim 14, wherein the one or more processors are further configured to:
remove the plurality of units based on the bounded plurality of shapes.

16. The apparatus of claim 13, wherein the key points can be assigned at any point within boundaries of each of the respective plurality of units.

17. The apparatus of claim 13, wherein the plurality of units includes a first unit and a second unit, and the second unit intersects the first unit.

18. The apparatus of claim 17, wherein the second unit intersects the first unit by at least one of a single point, by circles of varying sizes, and by regular or irregular contours.
